(19) United States
(12) Patent Application Publication
(10) Pub. No.: US 2015/0254213 A1
(43) Pub. Date: Sep. 10, 2015

(54) System and Method for Distilling Articles and Associating Images

(71) Applicants: Kevin D. McGushion, Semi Valley, CA (US); Christopher Mark Brahmer, Camarillo, CA (US)

(72) Inventors: Kevin D. McGushion, Semi Valley, CA (US); Christopher Mark Brahmer, Camarillo, CA (US)

(21) Appl. No.: 14/621,335

(22) Filed: Feb. 12, 2015

Related U.S. Application Data
(60) Provisional application No. 61/939,226, filed on Feb. 12, 2014.

(51) Int. Cl. G06F 17/21; G06F 3/0484

(52) U.S. Cl. CPC G06F 17/212; G06F 3/04842; G06F 17/214

(57) ABSTRACT

The present system is provided for of analyzing a body of text, such as a long-form news article, to detect a headline indicator for distinguishing a headline portion of the body of text, a lead paragraph indicator for distinguishing a lead portion of the body of text, and a conclusion paragraph indicator for distinguishing a conclusion portion of the body of text. Metadata, tags, text position, text formatting, font size, font color, and other properties may be utilized as indicators. The headline portion, the lead portion, and the conclusion portion may be displayed within an editing window to permit further refinement by a human editor. The edited portions may be associated with one or more images and published together as a summary of the article.

### RELATED APPLICATION DATA

This application claims the priority date of provisional application No. 61/939,226 filed on Feb. 12, 2014, which is hereby incorporated by reference in its entirety.

### BACKGROUND

The present method and user interface relates to methods of automatically summarizing content on a webpage, and, more particularly, automatically determining significant portions of text within an article or other long-form writing or data.

News and information articles can cover a wide variety of topics, and may solely exist on-line or have a corresponding print version, such as a newspaper or other periodical. The average article includes a headline and a body, where the body of a “long read” article has an average of 1000 words. When viewing a digitally delivered article on a website, RSS feed, or other digital delivery and viewing means, many readers read just the headlines. Often, those readers who begin reading the body of the article will not scroll down below the fold or load a second page to read the remainder of the article. Thus, the sole source of information for a great many readers is the headline and first few sentences. This leaves a substantial portion of the information contained in the body unread, leaving the average reader uninformed.

Whether in print or digital, the bodies of articles generally give background on the story, story context, interview quotes, and must provide a complete narrative by assuming the reader may know little about the subject matter. For stories that are ongoing, part of a series, or that cover developing situations, a large portion of the body may be dedicated to retelling prior versions of the story and filling in background, since many reader may not have read the previous related story. This repetitious model of storytelling creates overly-long and, for many, unreadable articles. Further, readers seldom have an hour to carefully read the day's articles in their entirety.

What is needed is a method and means for distilling the important aspects of a story into readable portions. The method and means should eliminate extraneous information that would cause an average reader to stop reading. The readable portion should be primarily contained above the fold, so that little or no scrolling is required.

### SUMMARY OF THE INVENTION

The present system is provided for of analyzing text where the text comprises a one or more characters, the method comprising the steps of, under control of one or more computing systems configured with executable instructions, receiving a body of text, analyzing the body of text to detect a headline indicator for distinguishing a headline portion of the body of text; analyzing the body of text to detect a lead paragraph indicator for distinguishing a lead portion of the body of text, analyzing the body of the text to detect a conclusion paragraph indicator for distinguishing a conclusion portion of the body of text, and displaying the headline portion, the lead portion, and the conclusion portion within a graphical user interface.

Optionally, the headline indicator is one or more of a title tag, a headline tag, a headline portion location within the body of the text, a font size, and a font color. And optionally, the lead paragraph indicator is one or more of a sub-headline tag, a headline tag, and a lead portion within the body of the text relative to the headline portion. Optionally, a suspect lead portion may be excluded, if one or both of a word count and a character count is less than a minimum count in the suspect lead portion. One or both of the word count and the character count may be restricted to counting one or both of words and characters between a start tag and an end tag. The start tag may be one of a paragraph start tag and a heading start tag, and wherein the end tag is one of a paragraph end tag and a heading end tag. A suspect lead portion may be excluded, if the suspect lead portion contains text matching one or more of a list of excluded text.

As an option, the number of paragraph elements may be counted by the software to determine a total number of paragraphs in the body of text. And the position of each counted paragraph may be determined relative to the remaining paragraphs. A mid-portion of the body of text may be determined by finding the quotient of the total number of paragraphs divided by two. Text between heading elements may be excluded in counting the total number of paragraphs.

As yet another option, at least one of the headline indicator, the lead paragraph indicator, and the conclusion paragraph indicator may be at least one HTML element. The body of text may be received from one of an address on the World Wide Web, a local server, and a remote server. Optionally, the body of text may be displayed in a first window within the graphical user interface. Emphasis may be added to at least one of the headline portion, the lead portion, and the conclusion portion within the body of the text in the first window, such as highlighting, underlining, and bolding.

Further, as an option, at least one of the headline portion, the lead portion, and the conclusion portion in a second window within the graphical user interface may be displayed in isolation from the body of the text. Editing of at least one of the headline portion, the lead portion, and the conclusion portion may be permitted within the second window. The headline portion may be displayed in a third window within the graphical user interface. Editing of the headline portion may be permitted within the third window. An edited headline portion, an edited lead portion, and an edited conclusion portion may be displayed in a fourth window within the graphical user interface.

Optionally, an image search may be initiated using selected keywords found within at least one of the first window, the second window, the third window, the fourth window, a keyword metadata, a summary metadata, a title tag, and a heading tag. At least one image may be associated with the edited headline portion, the edited lead portion, and the edited conclusion portion in a fourth window, where the image may be selected by an editor or automatically found within the image search query.

The edited headline portion, the edited lead portion, the edited conclusion portion, and the image may be optionally published within a reader user interface, such that a user may read the edited text and view the images together.

### BRIEF DESCRIPTION OF THE SEVERAL VIEWS OF THE DRAWINGS

Additional objects and features if the method will be more readily apparent from the following detailed description and appended claims when taken in conjunction with the drawings, in which:

FIG. 1 schematically illustrates an exemplary long-form article (200) as it might be displayed on a screen;

FIG. 2 schematically illustrates an exemplary article listing graphical user interface;

FIG. 3 schematically illustrates an exemplary bulleting tool graphical user interface;

FIG. 4 schematically illustrates an example embodiment of the reader graphical user interface; and

FIG. 5 schematically illustrates an alternate embodiment of the reader graphical user interface with a prior related article pane; and

FIG. 6A-N schematically illustrates several example embodiments of the reader graphical user interface.

### LISTING OF REFERENCE NUMERALS OF FIRST-PREFERRED EMBODIMENT

bulleting tool user interface 20
article box 22
highlighted portions box 24
first summary area 25
headline box 26
headline 27
first selected portion 28
second selected portion 30
third selected portion 32
delete selected portion icon 34
final summary area 36
character count 38
word count 40
first bullet point box 42
second bullet point box 44
third bullet point box 46
first associated image 48
second associated image 50
third associated image 52
delete image icon 54
first bullet point 56
second bullet point 58
third bullet point 60
select article icon 62
save article icon 64
delete article icon 66
list of summaries icon 68
URL entry box 70
publish article icon 72
preview article icon 74
first article title 76
second article title 78
third article title 80
edit article icon 82
delete article icon 84
article listing user interface 86
reader user interface 88
previous story icon 90
pause icon 92
play icon 94
next story icon 96
reading pane 98
visual pane 100
prior related articles pane 102
first prior story 104
second prior story 106
third prior story 108
original article 200
headline 202
lead 204
nutshell paragraph 206
story body 208
conclusion 210
midpoint 212

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

The present system and method provide a user interface tool for distilling a long-form article into one or more bullet points, with each bullet point having an associated image displayed in proximity to the bullet point, so that the reader quickly understands the primary aspects of a story through reading the text and viewing the associated image.

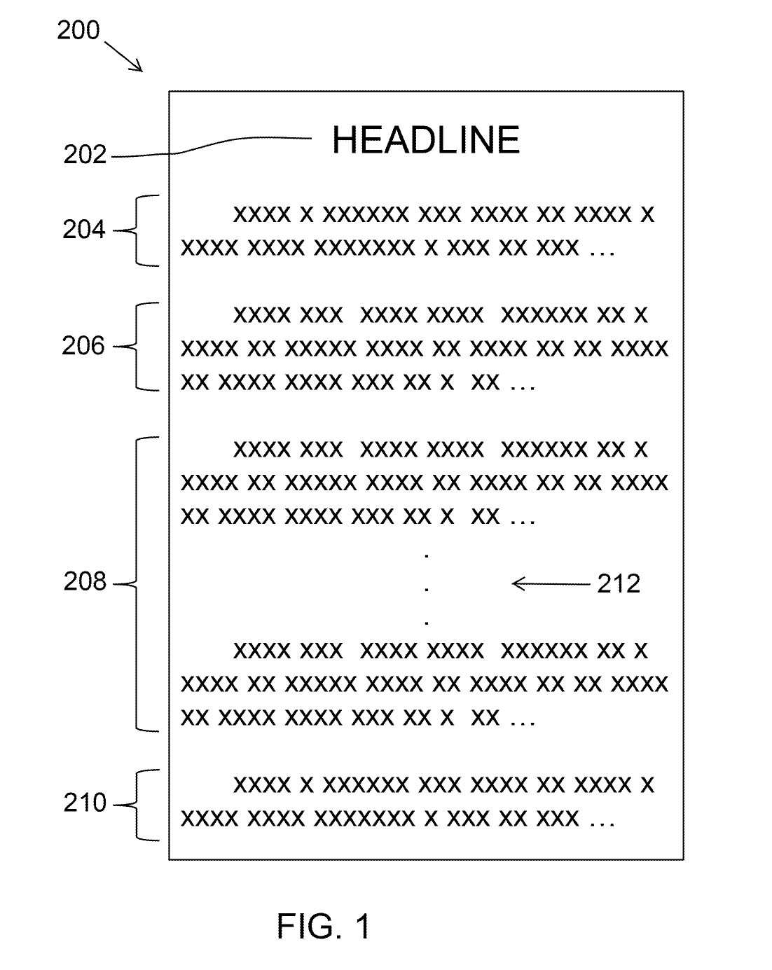

Example computer networks are well known in the art, often having one or more client computers and a server, on which any of the methods and systems of various embodiments may be implemented. In particular the computer system, or server in this example, may represent any of the computer systems and physical components necessary to perform the computerized methods discussed in connection with FIGS. 1-5 and, in particular, may represent a server (cloud, array, etc.), client, or other computer system upon which e-commerce servers, websites, web browsers and/or web analytic applications may be instantiated.

The illustrated exemplary server and client computer are known to a person of ordinary skill in the art, and may include a processor, a bus for communicating information, a main memory coupled to the bus for storing information and instructions to be executed by the processor and for storing temporary variables or other intermediate information during the execution of instructions by processor, a static storage device or other non-transitory computer readable medium for storing static information and instructions for the processor, and a storage device, such as a hard disk, may also be provided and coupled to the bus for storing information and instructions. The server and client computers may optionally be coupled to a display for displaying information. However, in the case of servers, such a display may not be present and all administration of the server may be via remote clients. Further, the server and client computers may optionally include an input device for communicating information and command selections to the processor, such as a keyboard, mouse, touchpad, and the like.

The server and client computers may also include a communication interface coupled to the bus, for providing two-way, wired and/or wireless data communication to and from the server and/or client computers. For example, the communications interface may send and receive signals via a local area network or other network, including the Internet.

In the present illustrated example, the hard drive of the server or the client computer is encoded with executable instructions, that when executed by a processor cause the processor to perform acts as described in the methods of FIGS. 1-5. The server communicates through the Internet with the client computer to cause information and/or graphics to be displayed on the screen, such as HTML code, text, images, and the like. The server may host the URL site with the article or other information, which may be accessed by the client computer. Information transmitted to the client computer may be stored and manipulated according to the methods described below, using the software encoded on the client device.

An exemplary long-form article (200) is schematically illustrated in FIG. 1, showing the approximate locations of the headline (202), the lead paragraph (204), the nutshell paragraph (206), the story body (208) that is generally comprised of multiple paragraphs, and a conclusion paragraph (210). Before a human editor or a secondary refined automatic editing is undertaken, each paragraph of the original article (200) must be analyzed by a software using known criteria which may be used to classify each paragraph by type, so that the human editor is not required to read the entire original article (200) and may focus solely on the portions of the article (200) highlighted or otherwise selected by the software.

An original article midpoint (212) general location is also indicated. The midpoint (212) can be determined automatically though an executable program that counts the total number of paragraphs in either the story body (208) or the entire article (200) and divides that number by two to determine the approximate midpoint paragraph number, where the paragraph numbering may start from the first full paragraph at the top of the article. For example, the executable program may count the number of start tag (<p>) and end tag (</p>) pairs between main element pairs (<main> and </main>), div element pairs (<div> and </div>), or other indicators of the start and end of the article. Then, the executable program (software) seeks the paragraph or paragraphs at or near the midpoint number of paragraphs. The midpoint is selected usually because important information may be located at or near the midpoint (212). Of course, if a pattern is discovered which locates critical information in another general area (e.g., one-third down, two thirds down, etc.), then the algorithm of the executable program can be adjusted to locate paragraphs in that general location in the article (200).

The executable software can also be used to determine the location and text of the headline (202), by detecting headline indicators, such as location, formatting, font size, font color, and other factors usually associated with headlines in general. These headline indicators can usually be found in the source code (HTML, etc.), such as a title tag (<title>XXXX(</title>) which would be displayed in the browser's title bar, a heading tag (<h1>XXXX</h1> or <h1 class=“title” itemprop=“headline”>XXXX</h1>), or similar indicator (like <hgroup> or similar); the series of X's represent text within the article headline or title. Generally, the headline (202) is located at or near the top of the article (200). Also, generally, the headline (202) font size is larger than the remainder of the article (202). Once the software has determined the text most likely to be a headline, that text can be highlighted, labeled, and/or classified as a headline (202). If other heading elements are present (such as <h2>, <h3>, <h4>, <h5>, or <h6>), the elements may be ranked according to importance, where <h2> is most important after <h1> and <h6> is least important. Although the exemplary code is HTML, any code for building an article page within a browser or similar display means may be analyzed and classified in a similar manner.

Often, an article (200) may have lead (204) or sub-headline, which is one or more short sentences or a sentence fragment at or near the top of the article (200) that piques the interest of the reader and causes her to become interested in the article (200). Like the headline (202), the lead (204) can be determined by the software by various indicators, such as a sub-headline tag or element (such as <h2 class=“sub-head” itemprop=“description”>XXXX</h2> or similar). The lead (204) is generally just beneath the headline (202). However, other non-essential information may also be in this location, such as the author's name, the date, the news outlet, and other information not pertinent to the story. Thus, certain keywords may be sought out, such as a line beginning with “by” or other keyword indicative of an author's name or a known news outlet (or elements, such as <address>). Further, the software may count the number of words and exclude any paragraph or sentence fragment with a word count that falls below a minimal threshold. For example, the software may exclude isolated paragraphs or sentences just beneath the headline and having less than five words. In this way, non-pertinent information is often excluded, minimized, or merely not highlighted. The minimum word count can change, depending on the circumstances. Once the most likely lead paragraph (204) is determined, it is highlighted and/or classified as a lead paragraph (204). The analysis to determine the most likely lead paragraph (206) may be restricted to text between paragraph elements (<p>XXXX</p>). Thus, in this example, the number of words between the start tag <p> and the end tag </p> (or other tag indicating the end of the paragraph) for each paragraph may be counted.

The nutshell paragraph (206) is generally one or two paragraphs that explain why the story is important, by providing the theme of the story and supporting facts or information. Basically, the “who, what, when, where, and why” is most likely provided in the nutshell (206). The nutshell paragraph is often just beneath the lead paragraph (204); or if there is no lead paragraph (204), the nutshell may be just below the headline (202). The program can often determine the nutshell paragraphs, again, by looking at certain indicators. Since supporting information is often provided in the nutshell paragraph (206) (such as dates, numbers, names, locations, etc.), the software algorithm can be optimized to seek out numbers, known names of public or private figures, words in mid-sentence starting with or having a capital letter, words preceding “Inc.”, and other indicators of important facts. Once a paragraph or two adjoining paragraphs are discovered meeting one or more of the above criteria, then that paragraph(s) is highlighted and/or classified as a nutshell paragraph. Yet another indicator of a nutshell paragraph may be determined by analyzing the metadata, such as the article description or summary metadata <meta name=“article.summary” content=“XXXXX.”/>. Further keywords from the keyword metadata may be used to search the article for matching keywords and/or a high density of matching keywords to determine the most important paragraphs, the nutshell paragraphs, or other paragraphs of interest.

The conclusion (210) is most often found at the very end of the article (200), at the last paragraph. Thus, the last paragraph that meets the minimum word count, will be highlighted and/or classified as a conclusion paragraph (210). As above, paragraph elements (<p> and/or </p>) or div elements (<div> and/or </div>) may be used to determine the final paragraph. Additionally, other elements may be used to indicate the final paragraph, such as the footer element (<footer>) or other indicator that the article text has ended. For example, the div or footer elements may indicate that the article ended one or more lines (of code) above the div or footer element, such as the closest prior </p> element or other end tag.

Paragraph-by-paragraph classification of the original article (200) may be completed automatically using the above described filtering criteria. This classification generally occurs when the URL is called up and built by the present software. Additionally, a list of URL's may be automatically generated, so that the software downloads the website associated with the URL and classifies the article (200).

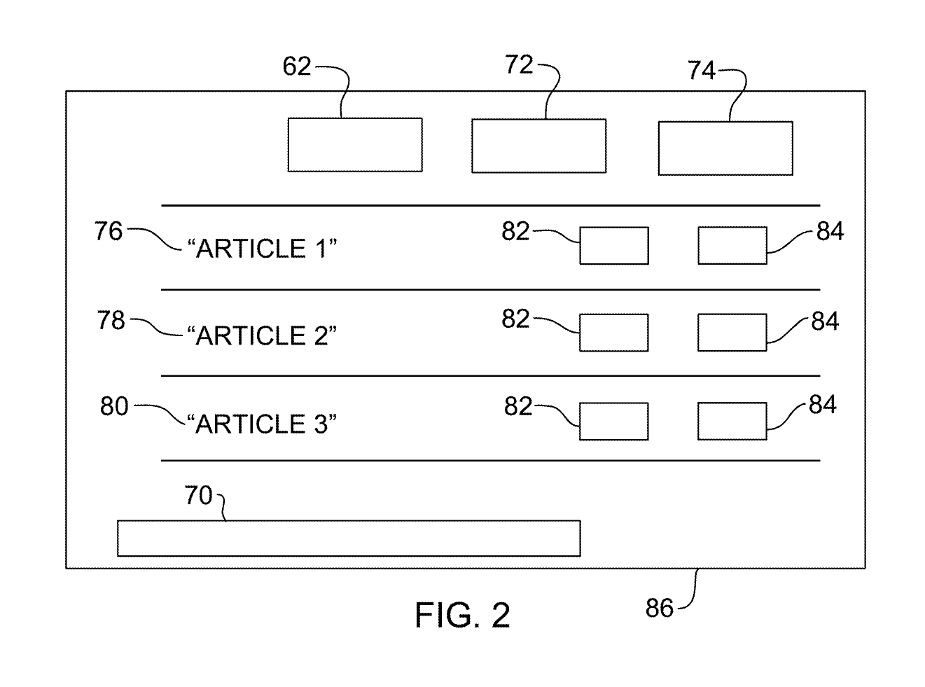

FIG. 2 shows a schematic of an exemplary article listing user interface (86), where a list of articles (76, 78, 80) or article links are displayed to a human editor. The list of articles (76, 78, 80) are articles which have been or may be reviewed by the human editor. The user interface (86) includes a select article icon (62), a publish article icon (72), and a preview article icon (74). The human editor selects the select article icon (62), which opens a page with a plurality of article links, categorized by subject, importance, by date, or other categorization method. The human editor enters or selects a link (URL) associated with an article (200), from within the user interface (86). Upon retrieval of the URL, the paragraphs of the article (200) are analyzed and classified as described above. The text of the headline (202) is then displayed within the list of articles on the user interface (86). For example, the first article headline (76) is located at the top of the list, followed by the second article headline (78), and then the third article headline (80). To the right of each article headline (76, 78, 80) are two icons, the edit article icon (82) and the delete article icon (84). Selecting the delete article icon (84) removes the article headline (76, 78, or 80) which is associated with the icon from the list. Selecting the edit article icon (82) opens the bulleting tool user interface (20), which is described in more detail below.

The editor may manually enter the text into the URL entry box (70), which will cause the article (200) associated with the URL to be downloaded and classified as described above. Then, the article headline is displayed within the list of article headlines (76, 78, 80). In the illustrated example embodiment, there are three article headlines in the list of article headlines (76, 78, 80); however, this list may include more or less headlines.

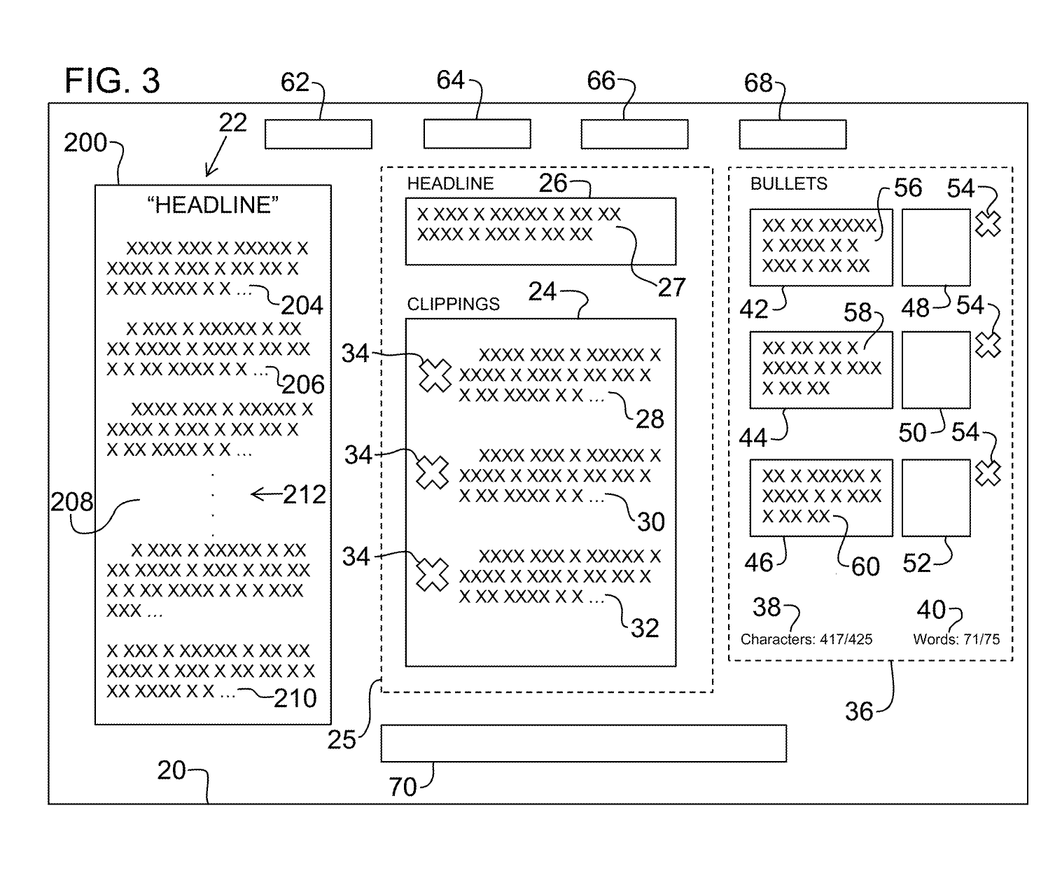

Selecting the edit article icon (82) opens and displays the bulleting tool user interface (20) for the article associated with that particular edit article icon (82) (e.g., the icon button may be aligned or within the same area as the headline for that article), as schematically illustrated in FIG. 3. The bulleting tool user interface (20) has three primary areas to aid in the distillation of the original long-form article (200) to a series of bullets, including the original article box (22), the first summary area (25), and the final summary area (36). As discussed above, the program automatically highlights (such as coloring the text area yellow, coloring the font of the text, bolding the text, or other similar formatting to draw attention to the most important paragraphs and portions) the potentially important paragraphs and sections of the original article (200), such as the headline (202), the lead (204), the nutshell (206), the midpoint paragraph (212), and the conclusion (210). The entire text with the highlighted portions of the text (or just highlighted portions of the text) of the original article (200) is displayed as text in the original article box (22).

The human editor has the option of reading the entire article (200) or just the automatically highlighted portions. The human editor can deselect an automatically highlighted portion, if she believes the portion is not pertinent to the story. The human editor can also select further portions by right-clicking and “mousing” over the desired text portion to create additional highlighted portions. Upon releasing the right mouse button, a confirmation box may be displayed which queries if the editor desires to add the user-highlighted portion to the highlighted portions box (24). If the editor confirms, then the highlighted portion, in its entirety, is moved to the highlighted portions box (24). As is well known in word processing, the selected text may also be moved by selecting with a mouse gesture, then clicking and dragging the text to the highlighted portions box (24).

The human editor also has the option of skipping the article listing user interface (86), and directly entering the text of a URL address into the URL entry box (70) within the bulleting tool user interface (20). The article associated with the URL is called up, classified, and then displayed as text in the article box (22). In this way, the human editor has the option of completely overriding the automatic classification of the article text. However, the human editing may solely be based on the displayed text of the article, and not the HTML code. Thus, for more complex articles or articles written in a non-standard format (perhaps a machine-translated article), a human editor may be required to refine the automatic classification.

Much like the article listing user interface (86) of FIG. 2, the user may select the select article icon (62) in FIG. 3 to call up an interface with numerous site links that the editor may select for classification and creation of a summary. The save article icon (64) may be selected to save the progress of the summarization and add the headline to the list of articles on the article listing user interface (86). The delete article icon (66) deletes the summary and removes the headline (27) from the article listing user interface (86). The list of articles icon (68) opens the article listing user interface (86) of FIG. 2.

Just to the right of the original article box (22) is the first summary area (25), with the headline box (26) and the highlighted portions box (24). The headline box (26) displays the headline (27) as editable text. When the human editor first views the headline box (26), the box (26) may be empty or the portion of the original article (22) that is determined by the software to most likely be the headline is automatically placed as text into the headline box (26). The human editor may edit the text or select new text from the article (200) to replace the automatically populated text. For example, a long headline may be shortened or changed completely.

Below the headline box (26) is the highlighted portions box (24), which would include all of the highlighted and/or selected portions of the original article (200). The highlighted portions box (24) may be initially empty or may be automatically populated with the portions selected by the software. For example, the first selected portion (28) may be the text of the lead (204) or nutshell (206) paragraphs, the second selected portion (30) may be the text of the midpoint paragraph (212), and the third selected portion may be the conclusion paragraph (210). Of course, there may be more or less than three selected portions, depending on the story and the editor's preference. Next to each selected portion (28, 30, 32) is a delete icon (34), which will remove the selected portion (28, 30, 32) associated with the delete icon (34) once selected. In this way, the human editor can add or remove text from the original article (200) to or from the highlighted portions box (24). Thus, the highlighted portions box (24) enables a preliminary round of distilling, where the text from entire selected portions of the original article (200) are displayed in the highlighted portions box (24), with each separate highlighted portion from the original article (200) displayed as a separate selected portion (28, 30, or 32).

To the right of the highlighted portions box (24) is the final summary area (36), where the human editor creates final bullet points (56, 58, 60). The number of bullet point boxes (42, 44, 46) are determined either manually by the editor, automatically by the number of selected portions (28, 30, 32), or may be a fixed number of boxes. The human editor either manually enters the text into each bullet point box (42, 44, 46) or copies parts of the text from the selected portions (28, 30, 32). The goal is to further summarize the information from the highlighted portions box (24) to create several final bullet points (56, 58, 60). The operation of creating final bullet points (56, 58, 60) may be automatically achieved through software analysis of the selected portions (28, 30, or 32). The software may select pertinent words, indicating names, dates, quantities, and so on, to form short sentences or fragments that can serve as final bullet points (56, 58, 60).

Next to each bullet point box (42, 44, 46) is an associate image (48, 50, 52). For example, looking at bullet point box (42), when the bullet point box (42) is empty, there is no associated image (48). When the editor enters the text of the final bullet point (56), the text is submitted to a search engine, which conducts an image search based on the text or selected portion of the text in the final bullet point (56). The image search generally produces multiple images, from which the editor may select the image which most closely conveys the subject matter of the associate bullet point (56) or other bullet point (58 or 60). Once a first associated image (48) is selected, it is displayed as a thumbnail. The second and third associated images (50, 52) may or may not be selected. If selected, the second and third associated images (50, 52) are generally complementary to the first associated image (48), by furthering the story communicated with the bullet points (56, 58, 60) and providing visual information differing from the other associated images. Additionally, the metadata on the site page may be used in determining the associate image (48, 50, 52). For example, the “keywords” or “news_keywords” metadata may be used to determine the image search keywords. In another example image links may be designated by the site within the metadata for use with social media or other quoting source, such as <meta name=“twitter:image” content=“http://website.com/images/samplepic.jpg”/> or <meta property=“og:image” content=“http://website.com/images/samplepic.jpg”/>. The image link designated in the metadata are generally closely related to the story, as they were selected by the original publisher.

Since there is a strong desire to maintain brevity in the final bullet points (56, 58, 60), a word count (40) and a character count (38) may be provided and limited. The character and word limits set may be inextensible or may merely provide an alert to the editor that the total characters/words of all the final bullet points (56, 58, 60) combined exceed the recommended limit.

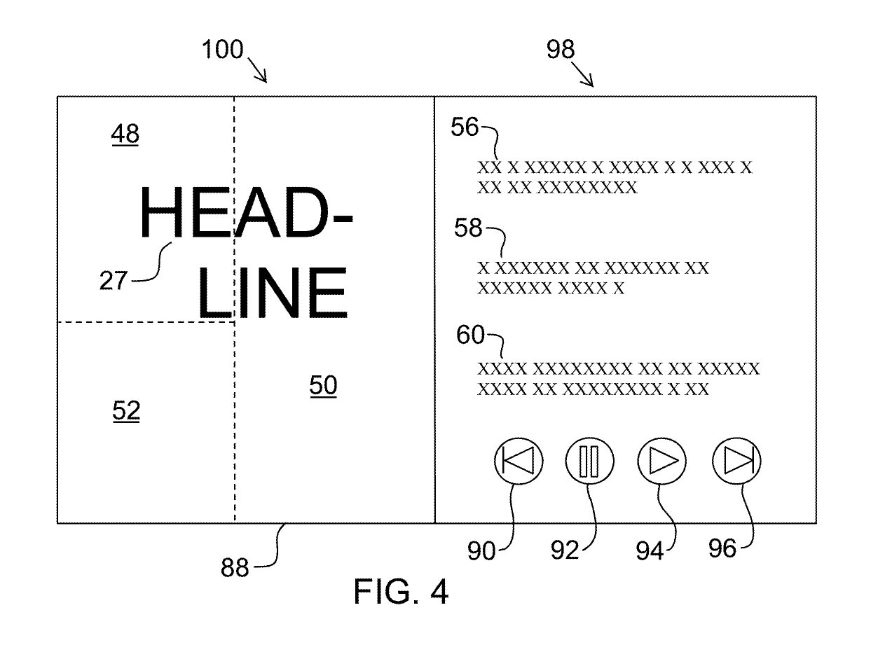

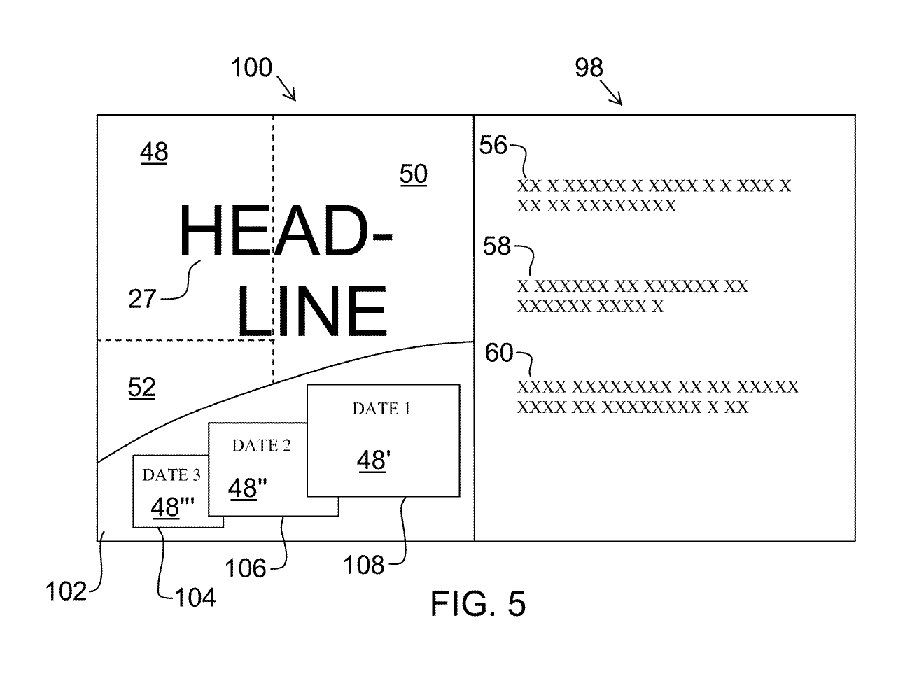

Once the final bullet points (56, 58, 60) are complete and the associated images (48, 50, 52) are selected, the editor may select the save article icon (64) to save the progress and open the article listing user interface (86) of FIG. 2. When the editor or other user is ready to publish the article summary, the user selects the publish article icon (72), which delivers the final bullet points (56, 58, 60) and the associated images (48, 50, 52) to a user accessible website for displaying the reader user interface (88), as shown in FIG. 4 and FIG. 5, where the user interface displays the final bullet points (56, 58, 60) and one or more associate images (48, 50, 52) to a human reader.

In particular, FIG. 4 shows an example embodiment of the reader user interface (88), with a visual pane (100) on the left, and a reading pane (98) on the right. Of course the arrangement can be reversed, pivoted to a top and bottom arrangement, or arranged in a completely differing manner. The visual pane (100) has one or more images either overlaid or adjacently arranged. In the illustrated example, the first associated image (48) has been located in the upper left corner of the visual pane (100), the third associated image (52) is directly adjacent and below, and the second associated image (50) is adjacent and to the right. Alternate visual panes (100) may have a primary image covering the entire pane, with a secondary image inset atop the primary image. To create a better user experience, the other image effects may be employed, such as zooming in, or shifting to one side of the image. The primary image may be displayed first, with the inset secondary image appearing several second later. Further, a first single image may occupy the entire visual pane (100) for a predetermined period; then a second single image may be displayed, replacing the first single image.

The headline (27) text may displayed on top of the image pane (100) in large text. The top portion of the image pane (100) may have a gradient effect to darkly shade the top portion, so that the headline (27) is more prominently displayed. In the reading pane (98), the final bullet points (56, 58, 60) are displayed in three distinct sentences or fragments, so that the reader may easily read and understand the bullet points. If more or less than three final bullet points (56, 58, 60), then the number of bullet points (56, 58, 60) in the reading pane (98) will be similarly adjusted.

The individually created story summaries are displayed sequentially, much like a slide show, retrieved form a list of completed and published summaries. The reader has the option of returning to a previously displayed story by selecting the previous story icon (90), or skipping to the next story by selecting the next story icon (96). The reader may select the pause icon (92) or the play icon (94) to continue. Further, the reader may select the reading pane (98) or the image pane (100) to be directed to the original article (200) or the source of the associated images (48, 50, 52). Alternatively or in addition to selecting icons to navigate to the next story, the reader user interface (88) may be configured to display the next story by receiving a swiping input, such as from a touch screen device or mouse action.

FIG. 5 discloses an alternate embodiment, which is similar in layout to the embodiment of FIG. 4 with the addition of a prior related article pane (102) overlaying the bottom portion of the image pane (100). If several articles are related to the same event that unfolds over time, then the reader has the option to select a previous, earlier story on the same or related subject matter. For example, the reader may read the current summary in the reading pane (98) and may require more background information on the story. Thus, the reader selects one of the prior summaries (104, 106, 108) whose links are represented visually by prior associated images (48′″, 48″,48′). The date of the prior summaries (104, 106, 108) may be provided atop each respective prior associated images (48′″, 48″,48′).

If there is an ongoing story that requires several summaries over time based on several articles, the software can optionally conduct a comparative analysis of the text of the related articles to determine which portions of the related stories are new and which are portions are repetitive of the prior story. For example, a first article in a series of articles may extensively explain the background of the story. A second article in the series may still include much of the background from the first article to fill in readers who missed the first. The comparative analysis would eliminate parts of the second article which substantially repeat the first article, by looking at similarities of groupings of words within a sentence and comparing to similar sentences in the first article, or detecting repetitive quantitative facts, and so on. In this way, the summaries in which summarize several related articles only includes new information.

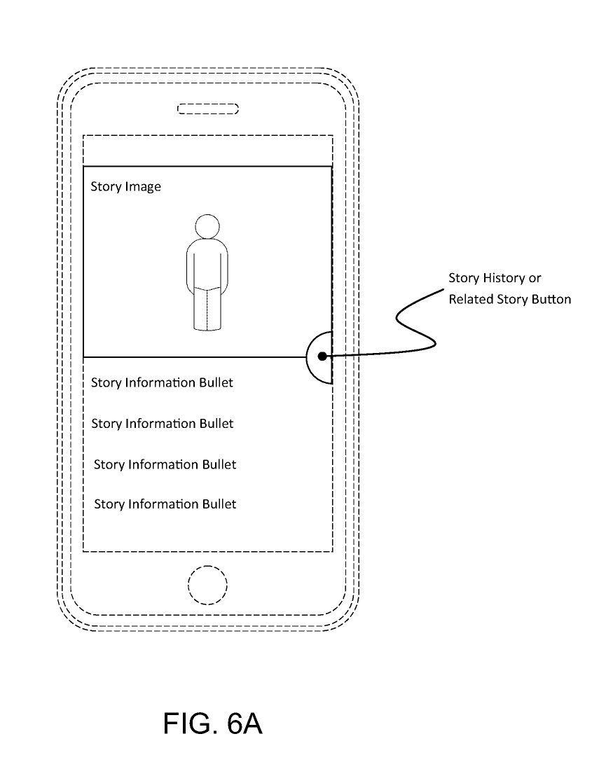

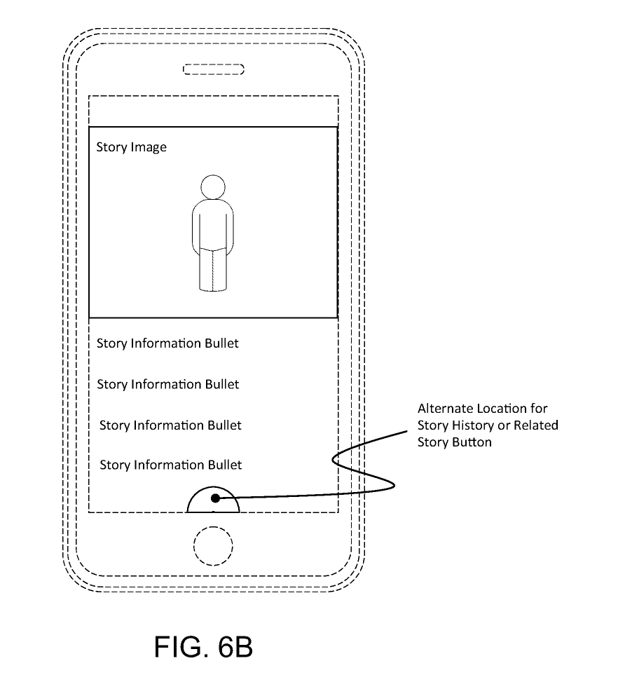

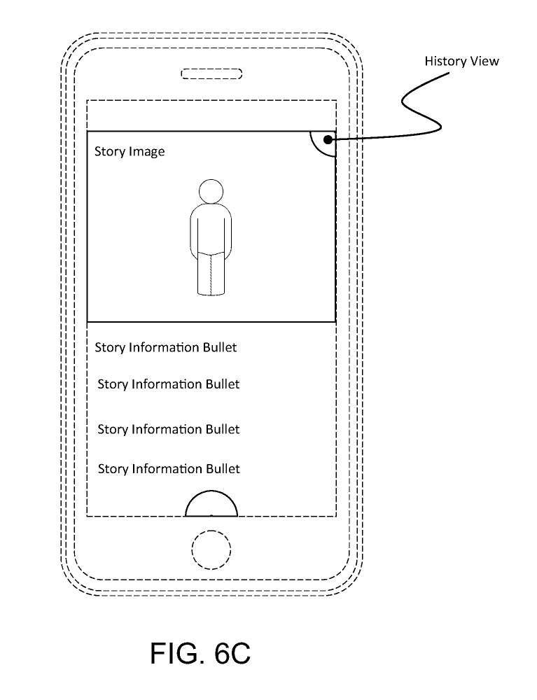

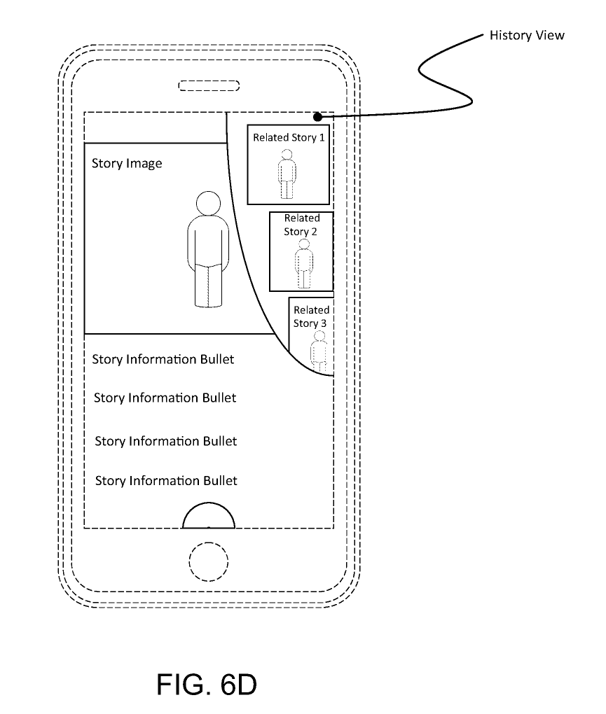

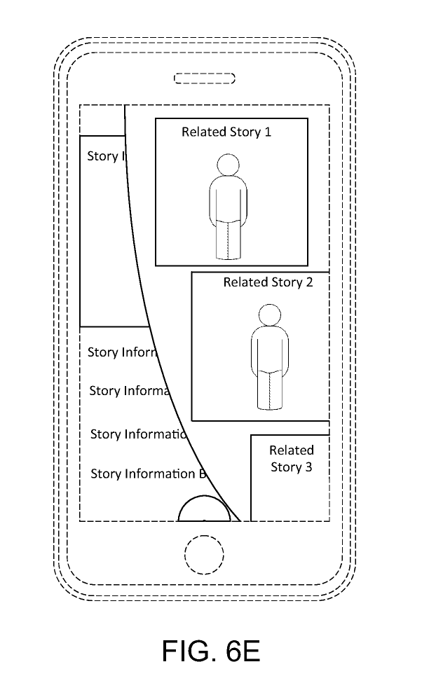

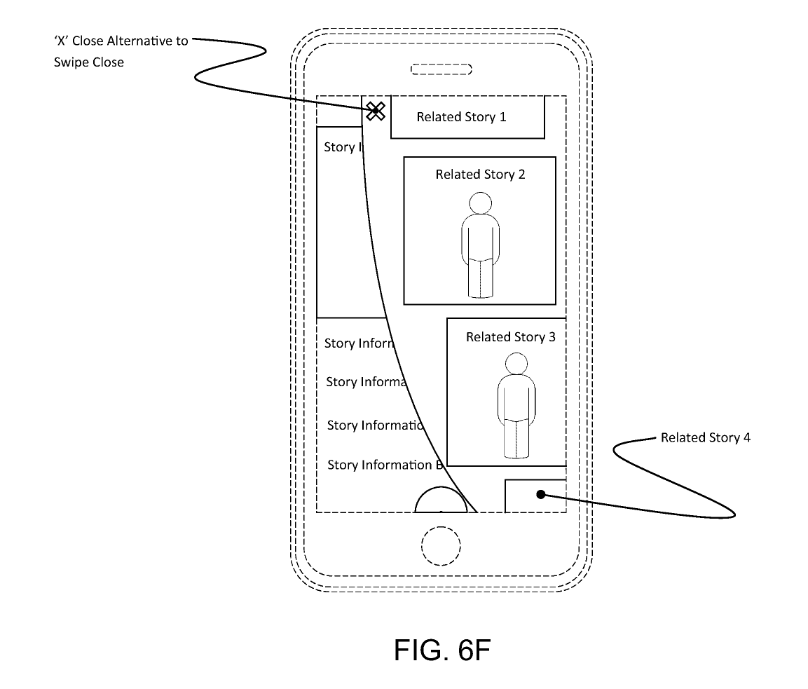

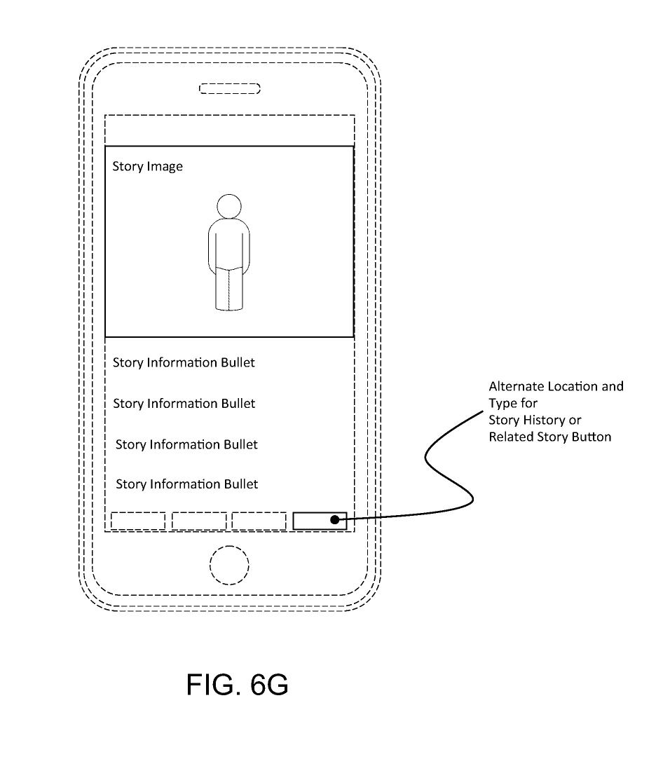

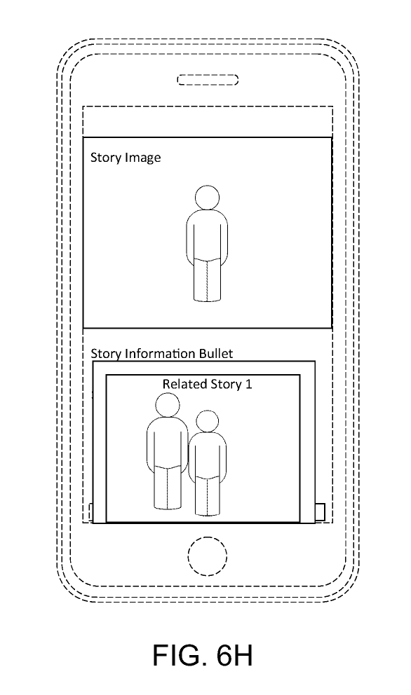

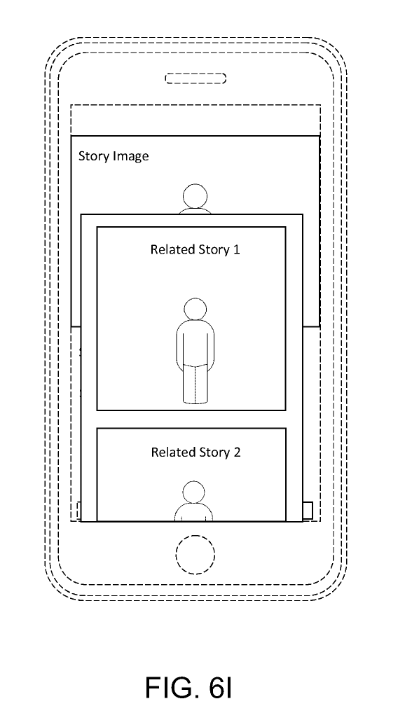

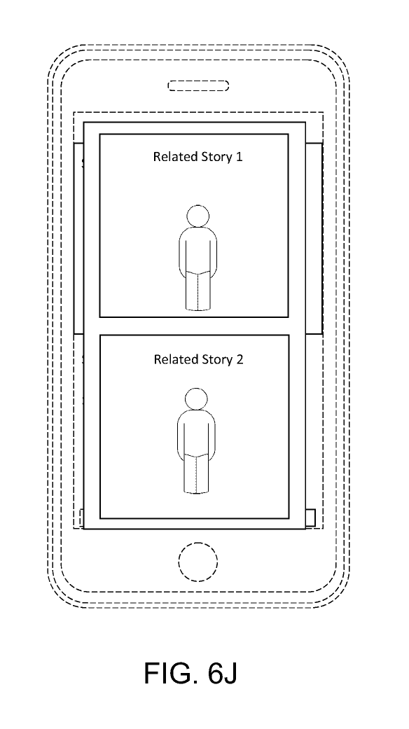

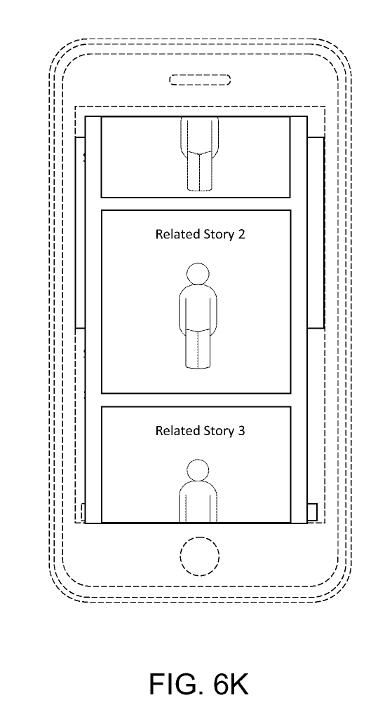

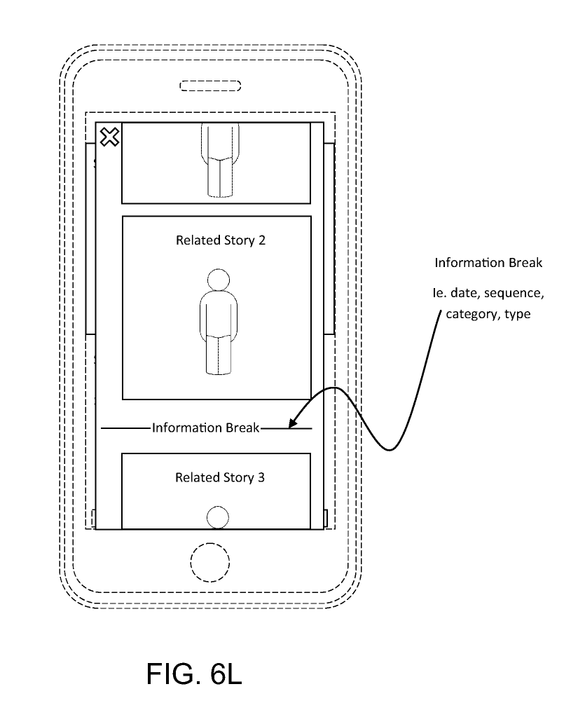

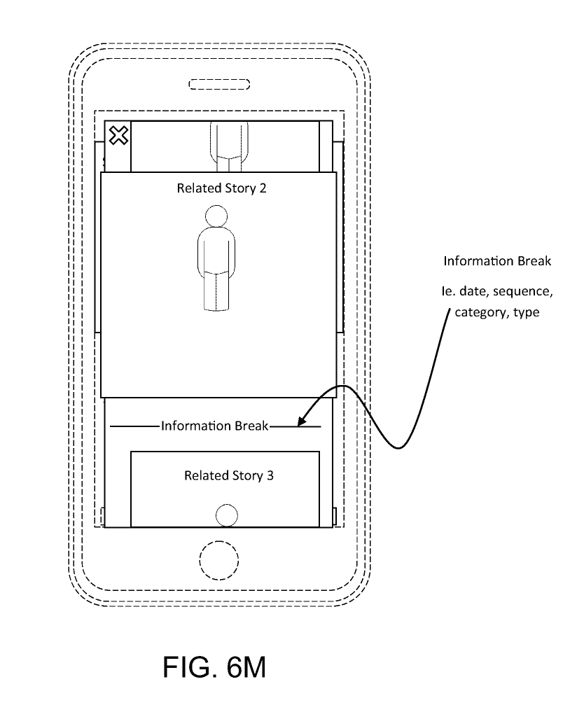

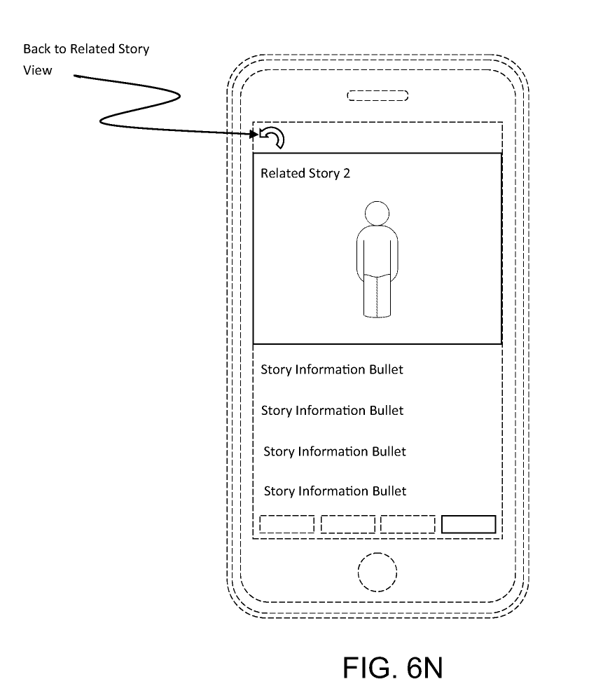

FIGS. 6A-N illustrate several alternate embodiments of the reader user interface (88), showing example prior related article panes (102) that may be expanded by touching or clicking on a button.

By present system and method employs distributed learning by associating a bullet point to an image that emphasizes the information provided in the bullet point. This engages multiple parts of the reader's brain. Further, by inducing motion within the image pane, such as pushing or pulling the image or panning, the reader is more engaged, resulting in higher retention of information.

What is claimed is:

1. A method of analyzing text where the text comprises a one or more characters, the method comprising the steps of:
under control of one or more computing systems configured with executable instructions;
receiving a body of text;
analyzing the body of text to detect a headline indicator for distinguishing a headline portion of the body of text;
analyzing the body of text to detect a lead paragraph indicator for distinguishing a lead portion of the body of text;
analyzing the body of the text to detect a conclusion paragraph indicator for distinguishing a conclusion portion of the body of text; and
displaying the headline portion, the lead portion, and the conclusion portion within a graphical user interface.

2. The method of claim 1 wherein the headline indicator is one or more of a title tag, a headline tag, a headline portion location within the body of the text, a font size, and a font color.

3. The method of claim 1 wherein the lead paragraph indicator is one or more of a sub-headline tag, a headline tag, and a lead portion within the body of the text relative to the headline portion.

4. The method of claim 3 further comprising the step of:
excluding a suspect lead portion, if one or both of a word count and a character count is less than a minimum count in the suspect lead portion.

5. The method of claim 4, wherein one or both of the word count and the character count is restricted to counting one or both of words and characters between a start tag and an end tag.

6. The method of claim 5, wherein the start tag is one of a paragraph start tag and a heading start tag, and wherein the end tag is one of a paragraph end tag and a heading end tag.

7. The method of claim 3 further comprising the step of:
excluding a suspect lead portion, if the suspect lead portion contains text matching one or more of a list of excluded text.

8. The method of claim 1 further comprising the steps of:
counting the number of paragraph elements to determine a total number of paragraphs in the body of text; and
determining the position of each counted paragraph relative to the remaining paragraphs.

9. The method of claim 8 further comprising the steps of:
determining a mid-portion of the body of text by finding the quotient of the total number of paragraphs divided by two.

10. The method of claim 9 further comprising the steps of:
excluding text between heading elements in counting the total number of paragraphs.

11. The method of claim 1, wherein at least one of the headline indicator, the lead paragraph indicator, and the conclusion paragraph indicator is at least one HTML element.

12. The method of claim 1, wherein the step of receiving a body of text further comprises the step of:
receiving the body of text from one of an address on the World Wide Web, a local server, and a remote server.

13. The method of claim 1, wherein the step of displaying the headline portion, the lead portion, and the conclusion portion within the graphical user interface further comprises the steps of:
displaying the body of text in a first window within the graphical user interface; and
adding emphasis to at least one of the headline portion, the lead portion, and the conclusion portion within the body of the text in the first window.

14. The method of claim 13 further comprising the steps of:
displaying in isolation of the body of text at least one of the headline portion, the lead portion, and the conclusion portion in a second window within the graphical user interface; and
permitting editing of at least one of the headline portion, the lead portion, and the conclusion portion within the second window.

15. The method of claim 14 further comprising the steps of:
displaying the headline portion in a third window within the graphical user interface; and
permitting editing of the headline portion within the third window.

16. The method of claim 15 further comprising the steps of:
displaying an edited headline portion, an edited lead portion, and an edited conclusion portion in a fourth window within the graphical user interface.

17. The method of claim 16 further comprising the steps of:
initiating an image search using selected keywords found within at least one of the first window, the second window, the third window, the fourth window, a keyword metadata, a summary metadata, a title tag, and a heading tag.

18. The method of claim 1 further comprising the steps of:
initiating an image search using selected keywords within one of a keyword metadata, a summary metadata, a title tag, and a heading tag.

19. The method of claim 17 further comprising the steps of:
associating at least one image with the edited headline portion, the edited lead portion, and the edited conclusion portion in a fourth window.

20. The method of claim 19 further comprising the steps of:
publishing the edited headline portion, the edited lead portion, the edited conclusion portion, and the image within a reader user interface.
